(19) United States
(12) Patent Application Publication
(10) Pub. No.: US 2022/0027406 A1
(43) Pub. Date: Jan. 27, 2022

(54) METHOD AND SYSTEM FOR USING GEOGRAPHIC INFORMATION TO DIRECT VIDEO

(71) Applicant: MOTOROLA SOLUTIONS, INC., CHICAGO, IL (US)

(72) Inventors: TRAVIS GREDLEY, MAPLE RIDGE (CA); KURT GROSSNICKLE, JENSEN BEACH, FL (US); KEN JESSEN, NEW WESTMINISTER (CA); MADISON JONES, NORTH VANCOUVER (CA); ZACHARY WEINGARTEN, PARKLAND, FL (US)

(21) Appl. No.: 16/936,615

(22) Filed: Jul. 23, 2020

(51) Int. Cl. G06F 16/58; G06F 16/51; G06F 16/535; G06F 16/587; G06F 16/583

(52) U.S. Cl. CPC G06F 16/5866; G06F 16/51; G06F 16/583; G06F 16/587; G06F 16/535

(57) ABSTRACT

A method is provided, comprising: receiving at a camera system comprising a plurality of video cameras, a search request from a mobile device, the search request comprising a geographic location of the mobile device and a time range; identifying one or more video cameras of the plurality of video cameras having a field of view including the geographic location; and transmitting search results from the one or more video cameras of the plurality of video cameras to the mobile device, the search results comprising at least an image from a video recorded by the one or more video cameras of the plurality of video cameras during the time range.

### BACKGROUND

In certain contexts, intelligent processing and playback of recorded video is an important function to have in a video surveillance system. For example, a video surveillance system may include many cameras, each of which records video. The total amount of video recorded by those cameras, much of which is typically recorded concurrently, makes relying upon manual location and tracking of an object-of-interest that appears in the recorded video inefficient. Intelligent processing and playback of video, and in particular automated search functionality, may accordingly be used to increase the efficiency with which an object-of-interest can be identified and located using a video surveillance system.

### BRIEF DESCRIPTION OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 shows a block diagram of an example video surveillance system within which methods in accordance with example embodiments can be carried out.

FIG. 2 shows a block diagram of a client-side video review application, in accordance with certain example embodiments, that can be provided within the example surveillance system of FIG. 1.

FIG. 3 shows an overhead view of a security system in accordance with certain example embodiments, including the fields of view of video cameras in the system.

FIG. 4 shows an overhead view of a camera installation environment in accordance with certain example embodiments.

FIG. 5 shows a flow chart in accordance with certain example embodiments.

FIG. 6 shows a block diagram in accordance with certain example embodiments, showing the information flow.

FIGS. 7A and 7B show a user interface page including an image from which a search request can be made, in accordance with certain example embodiments.

FIG. 8 shows a user interface page including the receipt of search results, in accordance with certain example embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF EXAMPLE EMBODIMENTS

According to a first aspect, there is provided a method comprising: receiving at a camera system comprising a plurality of video cameras, a search request from a mobile device, the search request comprising a geographic location of the mobile device and a time range; identifying one or more video cameras of the plurality of video cameras having a field of view including the geographic location; and transmitting search results from the one or more video cameras of the plurality of video cameras to the mobile device, the search results comprising at least an image from a video recorded by the one or more video cameras of the plurality of video cameras during the time range.

According to another aspect, the search request may include identification of one or more facets, the method further comprising: conducting an appearance search for the one or more facets within video recorded by the one or more cameras of the plurality of video cameras within the time range; and wherein the search results comprise the results of the appearance search from the one or more video cameras. The search results may be used to generate a second search request from the mobile device, the second search request comprising one or more images from the search results.

According to another aspect, the search request may include an image, the method further comprising: conducting an appearance search for the image within video recorded by the one or more cameras of the plurality of video cameras within the time range; and wherein the search results comprise the results of the appearance search from the one or more video cameras. The search results may be used to generate a second search request from the mobile device, the second search request comprising one or more images from the search results.

According to another aspect the image is taken by the mobile device. According to another aspect, the image was transmitted to the mobile device from an image source.

According to another aspect, the geographic location is determined using a global navigation satellite system (GNSS) on the mobile device. The GNSS may be a global positioning system (GPS).

According to another aspect, a method is provided, comprising: sending a search request from a mobile device to a camera system comprising a plurality of video cameras, the search request comprising a geographic location of the mobile device and a time range; and receiving, at the mobile device, search results from the one or more video cameras of the plurality of video cameras to the mobile device, the search results comprising at least an image from a video recorded by the one or more video cameras of the plurality of video cameras during the time range.

According to another aspect, a system is provided, comprising: a plurality of video cameras; a processor; and a memory storing program instructions that when executed by the processor cause the processor to perform: receiving a search request from a mobile device, the search request comprising a geographic location of the mobile device and a time range; identifying one or more video cameras of the plurality of video cameras having a field of view including the geographic location; and transmitting search results from the one or more video cameras of the plurality of video cameras to the mobile device, the search results comprising at least an image from a video recorded by the one or more video cameras of the plurality of video cameras during the time range.

According to another aspect, there is provided a system comprising: a display; an input device; a processor communicatively coupled to the display and the input device; and a memory communicatively coupled to the processor and having stored thereon computer program code that is executable by the processor, wherein the computer program code, when executed by the processor, causes the processor to perform the method of any of the foregoing aspects or suitable combinations thereof.

According to another aspect, there is provided a non-transitory computer readable medium having stored thereon computer program code that is executable by a processor and that, when executed by the processor, causes the processor to perform the method of any of the foregoing aspects or suitable combinations thereof.

Each of the above-mentioned embodiments will be discussed in more detail below, starting with example system and device architectures of the system in which the embodiments may be practiced, followed by an illustration of processing blocks for achieving an improved technical method, device, and system for using geographic information to direct video streaming. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

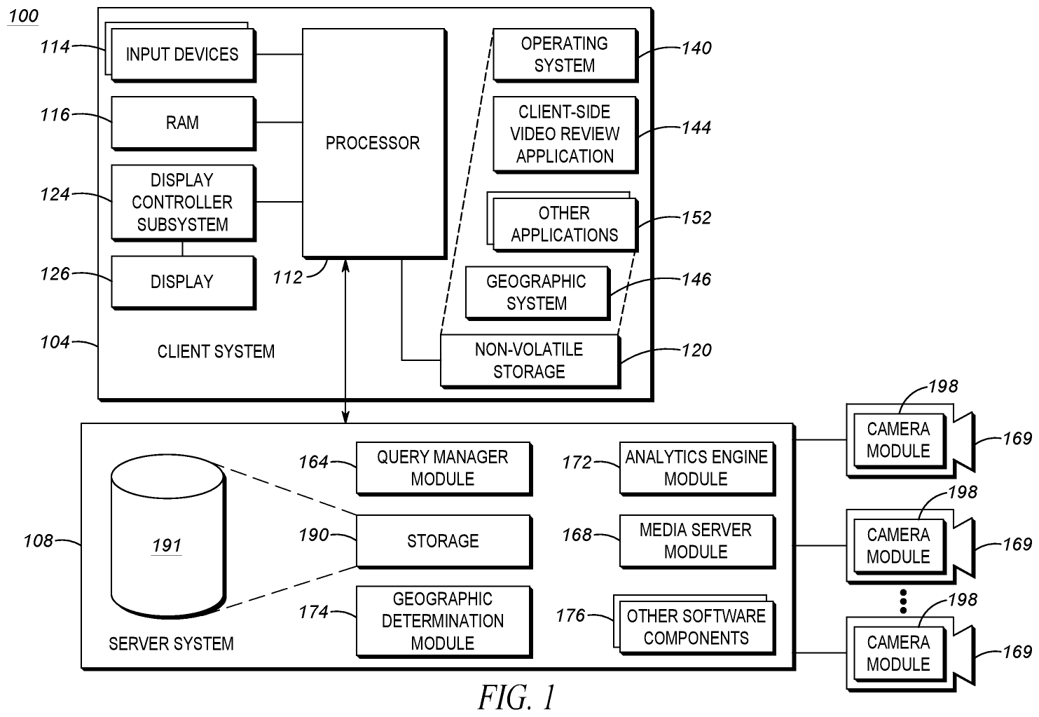

Reference is now made to FIG. 1 which shows a block diagram of an example surveillance system 100 within which methods in accordance with example embodiments can be carried out. Included within the illustrated surveillance system 100 are one or more client systems 104 and a server system 108. In some example embodiments, the client system 104 is a personal computer system; however in other example embodiments the client system 104 is a mobile device selected one or more of the following: a handheld device such as, for example, a tablet, a phablet, a smart phone or a personal digital assistant (PDA); a laptop; a two way radio, a body cam or vehicle system, and other suitable devices. With respect to the server system 108, this could comprise a single physical machine or multiple physical machines. It will be understood that the server system 108 need not be contained within a single chassis, nor necessarily will there be a single location for the server system 108. As will be appreciated by those skilled in the art, at least some of the functionality of the server system 108 can be implemented within the client systems 104 rather than within the server system 108.

The client system 104 communicates with the server system 108 through one or more networks. These networks can include the Internet, or one or more other public/private networks coupled together by network switches or other communication elements. The network(s) could be of the form of, for example, client-server networks, peer-to-peer networks, radio networks, etc. Data connections between the client system 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the client system 104 and the server system 108 are within the same Local Area Network (LAN). Client system 104 includes at least one processor 112 that controls the overall operation of the client system. The processor 112 interacts with various subsystems such as, for example, input devices 114 (such as a selected one or more of a keyboard, mouse, touch pad, roller ball and voice control means, for example), random access memory (RAM) 116, non-volatile storage 120, display controller subsystem 124 and other subsystems (not shown). The display controller subsystem 124 interacts with display 126 and it renders graphics and/or text upon the display 126.

Still with reference to the client system 104 of the surveillance system 100, operating system 140 and various software applications used by the processor 112 are stored in the non-volatile storage 120. The non-volatile storage 120 is, for example, one or more hard disks, solid state drives, an optical storage device, a magnetic storage device, a PROM (Programmable Read Only Memory), an EPROM (Erasable Programmable Read Only Memory), an EEPROM (Electrically Erasable Programmable

Read Only Memory) or a Flash memory, or some other suitable form of computer readable medium that retains recorded information after the client system 104 is turned off. Regarding the operating system 140, this includes software that manages computer hardware and software resources of the client system 104 and provides common services for computer programs.

Client system 104 includes a geographic system 146, which may be a global navigation satellite system (GNSS), such as a global positioning system (GPS), or may use tools such as cellular, wifi, or Bluetooth networks, or ultra wide band (UWB) systems, to determine the geographic location of the client system 104. Geographic system 146 outputs information which can be used by server system 108 to determine the geographic location of client system 104.

Also, those skilled in the art will appreciate that the operating system 140, client-side video review application 144, geographic system 146, and other applications 152, or parts thereof, may be temporarily loaded into a volatile store such as the RAM 116. The processor 112, in addition to its operating system functions, can enable execution of the various software applications on the client system 104.

More details of the video review application 144 are shown in the block diagram of

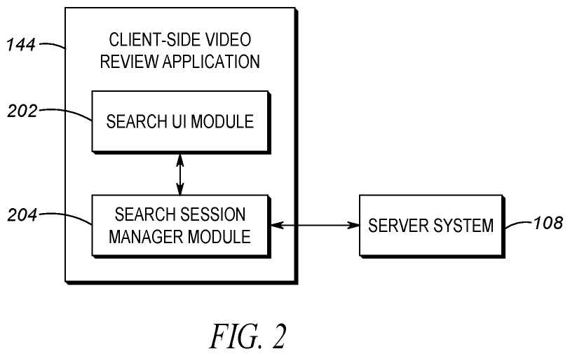

FIG. 2. The video review application 144 can be run on the client system 104 and includes a search User Interface (UI) module 202 for cooperation with a search session manager module 204 in order to enable a client system user to carry out actions related to providing input and, more specifically, input to facilitate identifying same individuals or objects appearing in a plurality of different video recordings. In such circumstances, the user of the client system 104 is provided with a user interface generated on the display 126 through which the user inputs and receives information in relation the video recordings.

The video review application 144 also includes the search session manager module 204 mentioned above. The search session manager module 204 provides a communications interface between the search UI module 202 and a query manager module 164 (FIG. 1) of the server system 108. In at least some examples, the search session manager module 204 communicates with the query manager module 164 through the use of Remote Procedure Calls (RPCs).

Besides the query manager module 164, the server system 108 includes several software components for carrying out other functions of the server system 108. For example, the server system 108 includes a media server module 168. The media server module 168 handles client requests related to storage and retrieval of video recorded by video cameras 169 in the surveillance system 100. The server system 108 also includes an analytics engine module 172. The analytics engine module 172 can, in some examples, be any suitable one of known commercially available software that carry out mathematical calculations (and other operations) to attempt computerized matching of same individuals or objects as between different portions of video recordings (or as between any reference image and video compared to the reference image). For example, the analytics engine module 172 can, in one specific example, be a software component of the Avigilon Control Center™ server software sold by Avigilon Corporation. In some examples the analytics engine module 172 can use the descriptive characteristics of the person's or object's appearance. Examples of these characteristics include the person's or object's shape, size, textures and color.

The server system 108 also includes a number of other software components 176. These other software components will vary depending on the requirements of the server system 108 within the overall system. As just one example, the other software components 176 might include special test and debugging software, or software to facilitate version updating of modules within the server system 108. The server system 108 also includes one or more data storage stores 190. In some examples, the data store 190 comprises one or more databases 191 which facilitate the organized storing of recorded video. The server system 108 also comprises a geographic determination module 174, which uses the output from geographic system 146 to determine the geographic location of client system 104.

Regarding the video cameras 169, each of these includes a camera module 198. In some examples, the camera module 198 includes one or more specialized integrated circuit chips to facilitate processing and encoding of video before it is even received by the server system 108. For instance, the specialized integrated circuit chip may be a System-on-Chip (SoC) solution including both an encoder and a Central Processing Unit (CPU) and/or Vision or Video Processing Unit (VPU). These permit the camera module 198 to carry out the processing and encoding functions. Also, in some examples, part of the processing functions of the camera module 198 includes creating metadata for recorded video. For instance, metadata may be generated relating to one or more foreground areas that the camera module 198 has detected, and the metadata may define the location and reference coordinates of the foreground visual object within the image frame. For example, the location metadata may be further used to generate a bounding box, typically rectangular in shape, outlining the detected foreground visual object. The image within the bounding box may be extracted for inclusion in metadata. The extracted image may alternately be smaller then what was in the bounding box or may be larger then what was in the bounding box. The size of the image being extracted can also be close to, but outside of, the actual boundaries of a detected object.

In some examples, the camera module 198 includes a number of submodules for video analytics such as, for instance, an object detection submodule, an instantaneous object classification submodule, a temporal object classification submodule and an object tracking submodule. Regarding the object detection submodule, such a submodule can be provided for detecting objects appearing in the field of view of the camera 169. The object detection submodule may employ any of various object detection methods understood by those skilled in the art such as, for example, motion detection and/or blob detection.

Regarding the object tracking submodule that may form part of the camera module 198, this may be operatively coupled to both the object detection submodule and the temporal object classification submodule. The object tracking submodule may be included for the purpose of temporally associating instances of an object detected by the object detection submodule. The object tracking submodule may also generate metadata corresponding to visual objects it tracks.

Regarding the instantaneous object classification submodule that may form part of the camera module 198, this may be operatively coupled to the object detection submodule and employed to determine a visual objects type (such as, for example, human, vehicle or animal) based upon a single instance of the object. The input to the instantaneous object classification submodule may optionally be a sub-region of an image in which the visual object-of-interest is located rather than the entire image frame.

Regarding the temporal object classification submodule that may form part of the camera module 198, this may be operatively coupled to the instantaneous object classification submodule and employed to maintain class information of an object over a period of time. The temporal object classification submodule may average the instantaneous class information of an object provided by the instantaneous classification submodule over a period of time during the lifetime of the object. In other words, the temporal object classification submodule may determine a type of an object based on its appearance in multiple frames. For example, gait analysis of the way a person walks can be useful to classify a person, or analysis of the legs of a person can be useful to classify a cyclist. The temporal object classification submodule may combine information regarding the trajectory of an object (e.g. whether the trajectory is smooth or chaotic, whether the object is moving or motionless) and confidence of the classifications made by the instantaneous object classification submodule averaged over multiple frames. For example, determined classification confidence values may be adjusted based on the smoothness of trajectory of the object. The temporal object classification submodule may assign an object to an unknown class until the visual object is classified by the instantaneous object classification submodule subsequent to a sufficient number of times and a predetermined number of statistics having been gathered. In classifying an object, the temporal object classification submodule may also take into account how long the object has been in the field of view. The temporal object classification submodule may make a final determination about the class of an object based on the information described above. The temporal object classification submodule may also use a hysteresis approach for changing the class of an object. More specifically, a threshold may be set for transitioning the classification of an object from unknown to a definite class, and that threshold may be larger than a threshold for the opposite transition (for example, from a human to unknown). The temporal object classification submodule may aggregate the classifications made by the instantaneous object classification submodule.

In accordance with at least some examples, a feature vector is an n-dimensional vector of numerical features (numbers) that represent an image of an object processable by computers. By comparing the feature vector of a first image of one object with the feature vector of a second image, a computer implementable process may determine whether the first image and the second image are images of the same object.

Similarity calculation can be just an extension of the above. Specifically, by calculating the Euclidean distance between two feature vectors of two images captured by one or more of the cameras 169, a computer implementable process can determine a similarity score to indicate how similar the two images may be.

In some examples, the camera module 198 is able to detect humans and extract images of humans with respective bounding boxes outlining the human objects and/or faces of the human objects for inclusion in metadata which along with the associated video may be transmitted to the server system 108. At the server system 108, the media server module 168 can process extracted images and generate signatures (e.g. feature vectors) to represent objects. In this example implementation, the media server module 168 uses a learning machine to process the bounding boxes to generate the feature vectors or signatures of the images of the objects captured in the video. The learning machine is for example a neural network such as a convolutional neural network (CNN) running on a GPU or VPU. The CNN may be trained using training datasets containing millions of pairs of similar and dissimilar images. The CNN, for example, is a Siamese network architecture trained with a contrastive loss function to train the neural networks. An example of a Siamese network is described in Bromley, Jane, et al. “Signature verification using a “Siamese” time delay neural network.” International Journal of Pattern Recognition and Artificial Intelligence 7.04 (1993): 669-688, the contents of which is hereby incorporated by reference in its entirety.

The media server module 168 deploys a trained model in what is known as batch learning where all of the training is done before it is used in the appearance search system. The trained model, in this embodiment, is a CNN learning model with one possible set of parameters. There is, practically speaking, an infinite number of possible sets of parameters for a given learning model. Optimization methods (such as stochastic gradient descent), and numerical gradient computation methods (such as backpropagation) may be used to find the set of parameters that minimize the objective function (also known as a loss function). A contrastive loss function may be used as the objective function. A contrastive loss function is defined such that it takes high values when it the current trained model is less accurate (assigns high distance to similar pairs, or low distance to dissimilar pairs), and low values when the current trained model is more accurate (assigns low distance to similar pairs, and high distance to dissimilar pairs). The training process is thus reduced to a minimization problem. The process of finding the most accurate model is the training process, the resulting model with the set of parameters is the trained model, and the set of parameters is not changed once it is deployed onto the appearance search system.

In at least some alternative example embodiments, the media server module 168 may determine feature vectors by implementing a learning machine using what is known as online machine learning algorithms. The media server module 168 deploys the learning machine with an initial set of parameters; however, the appearance search system keeps updating the parameters of the model based on some source of truth (for example, user feedback in the selection of the images of the objects of interest). Such learning machines also include other types of neural networks as well as convolutional neural networks.

In accordance with at least some examples, storage of feature vectors within the surveillance system 100 is contemplated. For instance, feature vectors may be indexed and stored in the database 191 with respective video. The feature vectors may also be associated with reference coordinates to where extracted images of respective objects are located in respective video. Storing may include storing video with, for example, time stamps, camera identifications, metadata with the feature vectors and reference coordinates, etc.

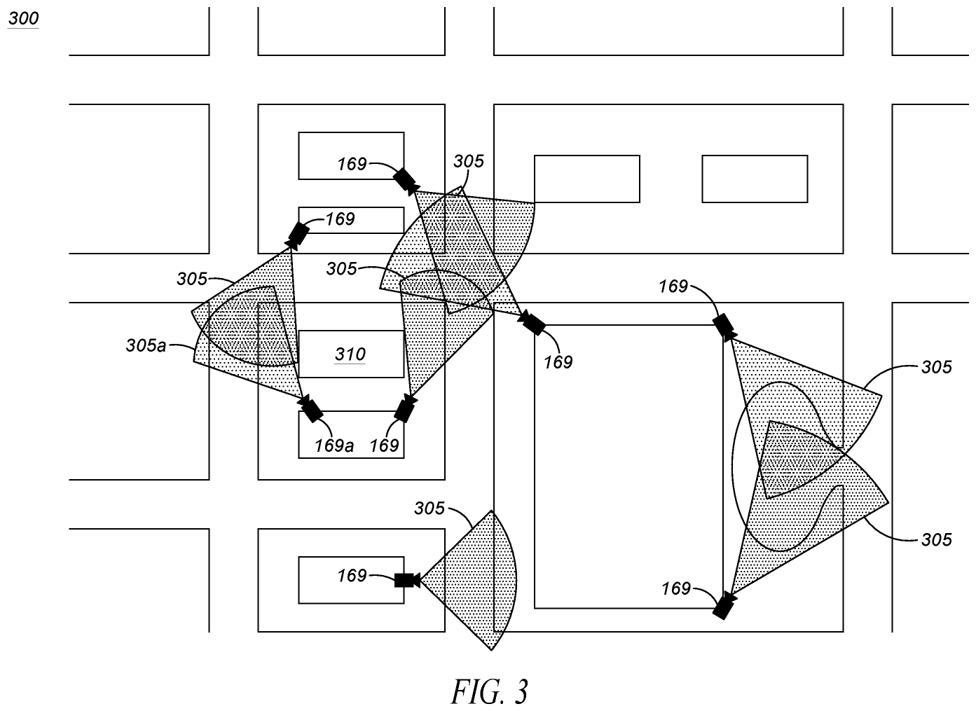

Reference is now made to FIG. 3, which shows video cameras 169 positioned in a geographic region 300. Geographic region 300 as shown, displays a plurality of street intersections, although geographic region 300 could be any region, outdoor or indoor, and could for example, be the interior of a building, or the area including and around a facility, such as a manufacturing plant, university, stadium, hospital or the like.

Each video camera 169 has a corresponding field of view 305, which represents the geographical bounds of the images recorded by the video camera 169. Fields of view 305 may be limited in their geographical viewpoint as shown in FIG. 3, for example because of obstructing objects, for example building 310, which as shown in the example geographic region 300, partially obstructs the geographical bounds of the field of view 305a of camera 169a. The depth of field of view 305 may also depend on the characteristics of camera 169, for example a higher megapixel camera 169 would have a deeper field of view than a camera 169 with a lower megapixel value. The depth of field of view 305 may depend on the maximum range at which camera 169 can detect objects reliably and use these objects in an appearance search, using images or facets.

The geographical boundary of fields of view 305 is known to video camera 169 and/or server system 108. For example, the GPS coordinates of the field of view 305 may be known and/or latitude and longitude or other geographical measurements. The geographic boundary may be manually input during set up of the cameras, or may be determined when calibrating camera 169; the geographic boundary may be based on the GPS determined location of camera 169, and a calculation of the geographic boundaries of the field of view.

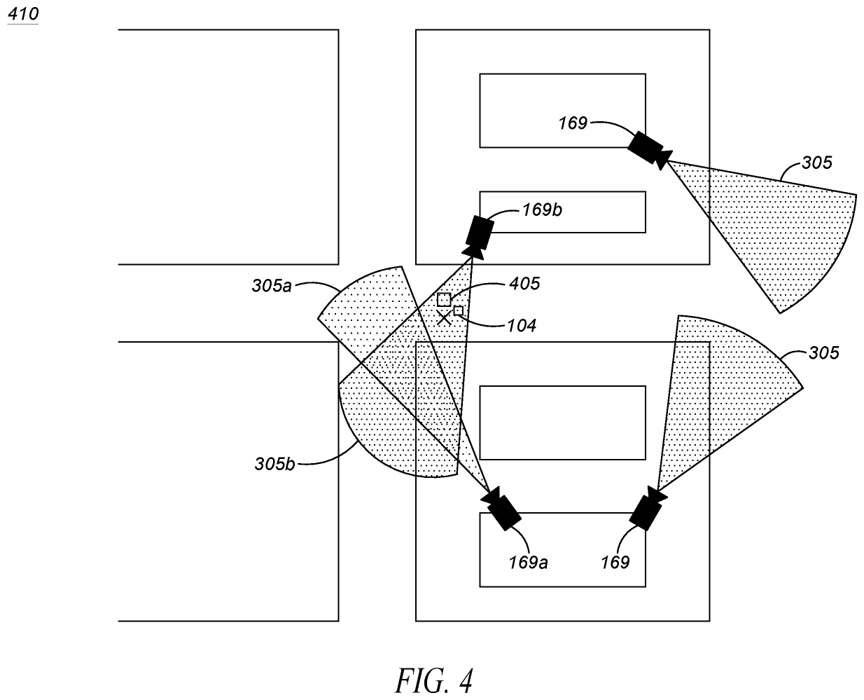

Reference is now made to FIG. 4, which shows a sub region 410 of geographic region 300. Two video cameras 169a,b have corresponding fields of views 305a,b. Client system 104 is located in the field of view 305b of video camera 169b. Operator 405 operates client system 104. An incident may have occurred at location X, within the field of view 305b of video camera 169b, and the operator 405 may be desirous of viewing recorded video footage related to the incident.

In an example use case, operator 405 has arrived at location X, the scene of an incident. Operator 405 may be, for example a police officer, and the incident may be for example, a crime. Alternatively, operator 405 may be a different first responder or investigator. Operator 405 carries or has access to client system 104 at location X. Client system 104 is a mobile device as previously described, and for example may be a mobile smart phone, a tablet, or a portable radio transceiver. The incident may have been a crime or accident, or another event such as a fire, or a report of the presence of a person of interest.

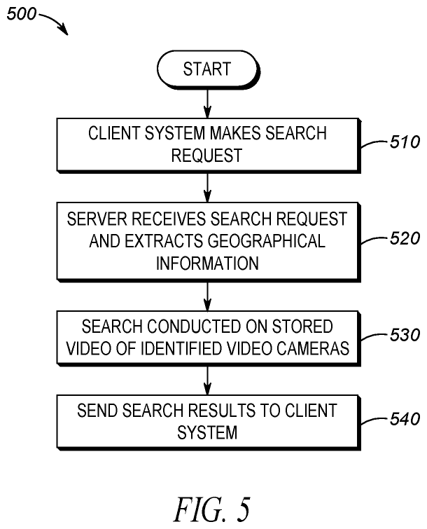

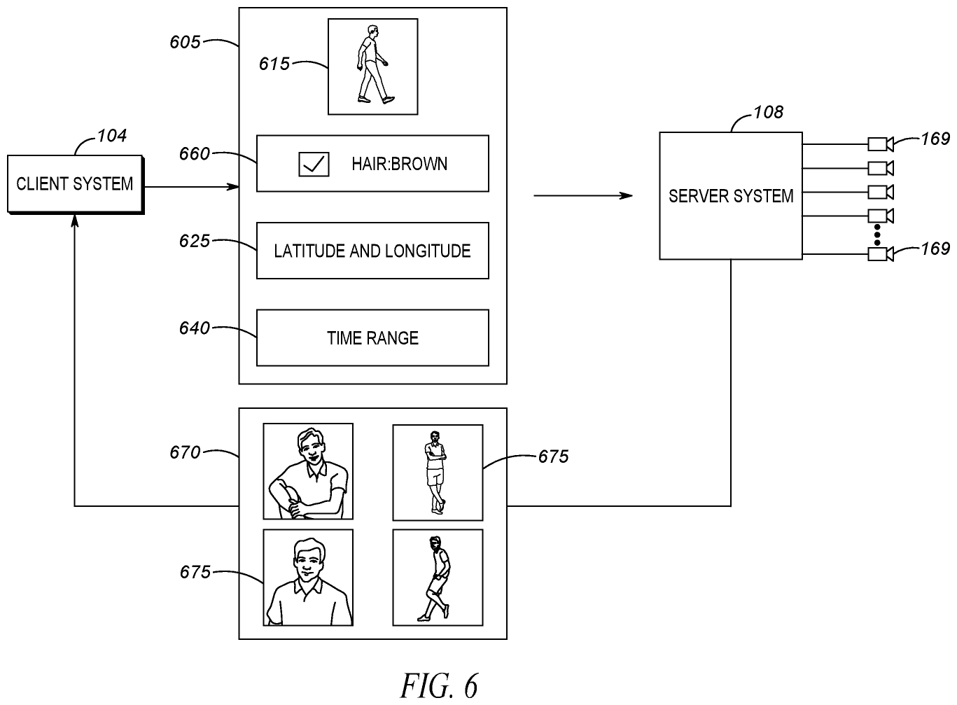

Reference is now made to FIG. 5, showing a flow chart of method 500, in accordance with certain embodiments. At block 510, a user uses client system 104 to make a search request 605 (as shown in FIG. 6). The search request 605 may be for an appearance search as described above, in which case, the search request 605 would include an image 615 to serve as an instance of the object to search. The image 615 could be, for example, a photo taken using the client system 104 of, for example, a victim of a crime, or a suspect.

Alternatively, the search request 605 could be based on facets of the object of interest. For example, the operator 405 may be a police officer who has obtained a description of a person or vehicle that had been present at location X, and operator 405 could then transmit a search request 605 using facets, such as, for a person, age, gender, hair colour, clothing upper body colour, clothing lower body colour, weight, height, ethnicity, and/or accessories (e.g. glasses, hat, etc.); and for a vehicle, type, colour, make/model, and/or license plate.

Search request 605 includes geographic information 625 about client system 104 from geographical system 146. This may include GPS information and the like as previously described. The search request 605 may also include a time range 640 to serve as a filter for the stored video that will be searched. The time range 640 may be a bounded time range, or may be relative to the search request, e.g. “within the last three hours”.

Search request 605 is then processed by server system 108. Geographic determination module 174 of server system 108 extracts geographic information 625, at block 515 and identifies which video cameras 169 have a field of view 305 of the location corresponding to the geographic information 625. Using the example embodiment set out in FIG. 4, on receiving the search request 605 from client system 104, server system 108 determines that video camera 169b has a field of view 305b including client system 104.

At 530, server system 108 then conducts the search, using the information provided by the client system 104, for example an image or facets, for stored video associated with cameras having a field of view associated with the location of the client system 104, and within the time range 640 provided in the search request 605.

At 540, the search results 670 are then sent from server system 108 to client system 104, where they are displayed on client system 104 for review by operator 405. Operator 405 may use client system 104 to initiate another search based on the results (by for example, selecting specific images for further searching or to improve the quality of the search, or by transitioning from a facet search based on information provided to an appearance search based on one or more images returned in the facet search).

Reference is now made to FIG. 6, showing the information flow in accordance with certain embodiments. Client system 104 sends search request 605 to server system 108. Search request 605 includes geographic information 625, as derived from geographic system 146 in client system 104, and which may be latitude and longitude, and time range 640. If no time range 640 is included, server system 108 may use a default or predetermined time range.

Search request 605 also includes image 615 and/or facets 660. Image 615 is selected by operator 405, and may be a facial image or a full body image of an object of interest for use in a search, such as an appearance search or a facial recognition search. The object of interest may be a person, a vehicle, or another object. Facets 660 may be the elements of a person searched for that are typically selected from a list, and may relate to age, gender, hair colour, clothing upper body colour, clothing lower body colour, weight, height, ethnicity, and/or accessories (e.g. glasses, hat, etc.). Alternatively, if a vehicle is the subject of search request 605, elements of the vehicle selectable from a list, or entered by operator 405 may include license plate, color, make and model of the vehicle or type of vehicle.

On receipt of search request 605, server system 108, through geographic determination module 174, extracts geographic information 625, and determines which of cameras 169 has a field of view that includes the geographic location represented by geographic information 625. A search is then conducted through stored video associated with the identified cameras using image 615 and/or facets 660.

The search results 670 are then returned to client system 104. Search results 670 are, for example, a set of images 675 determined to have a sufficient confidence of including the identified facets 660 or as having a sufficient confidence as being similar to image 615. Operator 405 may conduct another search adding one or more selected images 675 from the search results 670 to the original image, or converting a facet based search into an appearance search or facial recognition search by selecting one or more of images 675 for a further search.

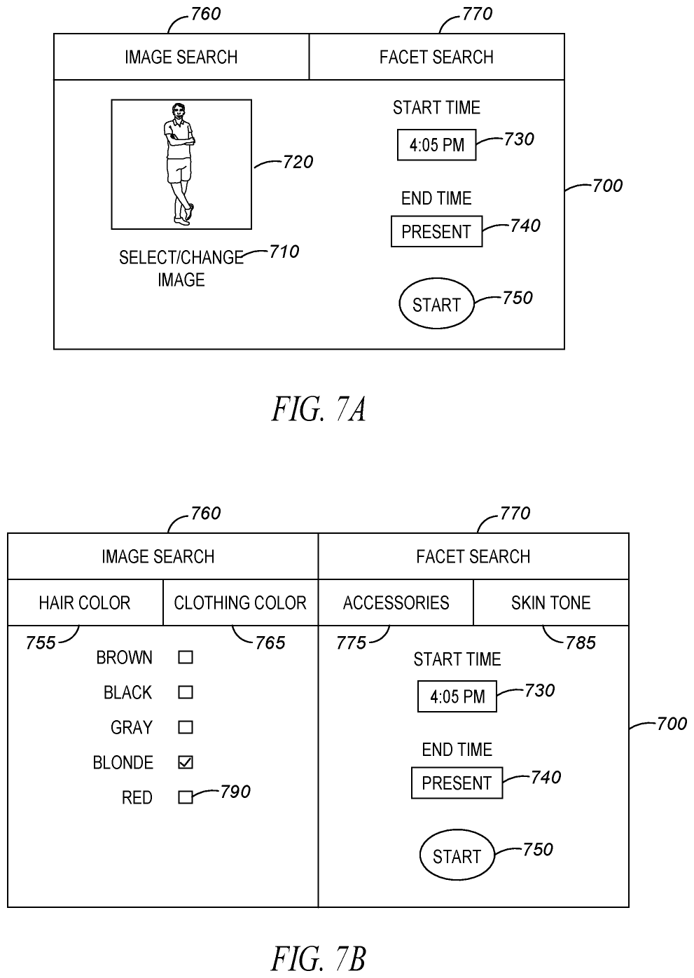

Reference is now made to FIG. 7A, showing a user interface 700 which operator 405 may use to make a search request 605 in accordance with certain embodiments. User interface 700 is displayed to operator 405 on client system 104. Operator 405 may select Image Search tab 760 or Facet Search tab 770, depending on the type of search preferred. FIG. 7A shows the Image Search tab 760 having been selected, according to an embodiment, allowing operator 405 to select a search using an image 720. Selecting the Select/Change Image 710 allows operator 405 to select an image 720 stored on client system 104 in non-volatile storage 120 for use in the search. Image 720 may default to the last image taken or received by client system 104. Operator 405 may also select a start time 730 and end time 740 for the search; these fields may be preset with defaults, for example End Time 740 may default to the current time, and Start Time may default to the preceding twelve hours. Once the search parameters are complete, using a combination of selected and default parameters, the operator 405 can select Start 750 to transmit the search request 605 to server system 108. In an embodiment, operator 405 may select a video for transmission in search request 605, rather than, or in addition to, image 615.

Reference is now made to FIG. 7B, showing a user interface 700 which operator 405 may use to make a search request 605 in accordance with certain embodiments. User interface 700 is displayed to operator 405 on client system 104. Operator 405 may select Image Search tab 760 or Facet Search tab 770, depending on the type of search preferred. FIG. 7B shows the Facet Search tab, allowing operator 405 to select a search using selected facets 660, also referred to as attributes of an object. Several tabs are presented to operator 405 for various categories of facets, for example as shown Hair Color tab 755 has been selected, while other available tabs include Clothing Color 765, Accessories 775, and Skin Tone 785. Other facet options as noted above for people and/or vehicles may be presented. Operator 405 can select checkboxes 790 to select the facet associated with the checkbox 790. In the example shown in FIG. 7B, operator 40 has selected the checkbox 790 associated with “Red”, meaning a search can be conducted for a person with red hair. Operator 405 may also select a start time 730 and end time 740 for the search; these fields may be preset with defaults, for example End Time 740 may default to the current time (indicated as “Present”), and Start Time 730 may default to the preceding twelve hours. Once the search parameters are complete, using a combination of selected and default parameters, the operator 405 can select Start 750 to transmit the search request 605 to server system 108.

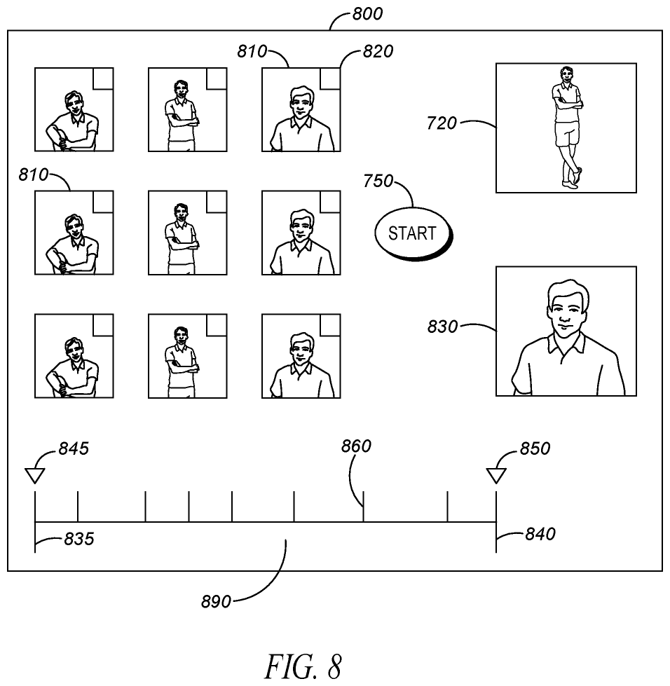

Reference is now made to FIG. 8, showing a user interface 800 for client system 104 displaying search results 670 to operator 405. Each image 810 within search results 670, are displayed in a series of columns and rows, and, for example in certain embodiments, may be ordered based on the confidence of the particular image matching the image 720 or facets 660 as determined by server system 108. In alternative embodiments, images 810 may be ordered by time of appearance or other metrics. Image 720, if an image search was requested is displayed, is the image 720 used in search request 605. If images 810 are the result of a search using facets, the selected facets may be presented in place of image 720. Image 830 is a larger version of an image 810 selected from search results 670.

Timeline 890 is also displayed, including start time 835 and end time 840. Start slider 845 and end slider 850 can be moved by operator 405, to adjust the start time 730 and end time 740 in subsequent searches and to adjust the search results 670 images 810 displayed. Indicators 860 show where search results 670 are present on the timeline and can be used to select an image 810 for display as image 830. Operator 405 can also play a video clip associated with each image 810 by selecting the image 810 associated with the desired video.

Checkboxes 820 can be used to select one or more images for a further image search. Thus operator 405 can finetune the searching by adding images that match and adjusting the time range of the search. Once the images 810 for the search are selected and/or the timeline adjusted, operator 405 can select start 750 to initiate a new search.

Operator 405 can obtain recorded video of a location using geographic information 625 of the requesting client system 104. As operator 405 moves around an environment to a different location X₁, the geographic information 625, e.g. GPS coordinates, may change, and a different camera 169 may have a field of view including the new location X₁, so that search results 670 may be different.

In an example embodiment, rather than conducting a search, on receiving a request from client system 104, the request including geographic information 625, the server system 108 can return a live video feed from cameras 169 having a field of view including the geographic coordinates. Server system 108 will periodically query client system 104 for updated geographic information 625. As the operator 405 moves to a new location X₁ from location X, the camera feed from server 108 to client system 104 may adjust based on the new geographic information 625 associated client system 104 as a video feed from a camera 169 with a field of view no longer including location X₁ will be excluded, and a video feed from camera 169 with a field of view including location X₁, but not the original location X, will be added.

In another example embodiment each client system 104 in communication with server system 108 is able to direct search results or video footage based on the location of the requesting client system 104 to one or more of different client systems 104. The additional client systems 104 to receive the results can be selected by operator 405 and are included in search request 605.

If more than one camera 169 has a field of view including the location associated with client system 104, then in an example embodiment, client system 104 may present a list of cameras 169 and a location associated with each camera that has a field of view including client system 104, which operator 405 may select for a live video feed or search request.

In another example embodiment, a first client system 104 may conduct an appearance search based on geographic information associated with a second client system 104 or using geographic information based on other means for obtaining geographic information, for example selecting a location on map through a user interface.

The results of the search may be sent to the first client system 104, second client system 104, or both client systems.

In another example embodiment, the results of the appearance search may indicate the direction of travel indicated by the search results, and list for selection additional cameras 169 with a field of view 305 in the direction of travel. Operator 405 may then conduct a second appearance search including video captured by the additional cameras 169 by selecting such additional cameras.

In another example embodiment, operator 405 can conduct a search for a license plate from client system 104. The operator may enter details through a user interface including a full or partial license plate and/or facets relating to the vehicle, such as the vehicle make, model, and colour, identifying marks (e.g. broken window, bumper sticker, etc.), the last known direction of travel, as well as a time range. Server system 108 then identifies cameras 169 with a field of view including the client system 104 as described above and returns the search results to the client system 104.

In another example embodiment, operator 405 can request a search using client system 104 for an animal, for example a lost pet, using an image of the animal and/or facets such as species (e.g. cat, dog, rabbit, bird, etc.), colour, breed, size, and a time range. The server system 108 uses this information, along with the client system 104 location as described above, to determine cameras 169 with a field of view including client system 104 and returns search results to the client system 104.

In another example embodiment, a facet search may include events selectable by operator 405. These events may be determined by analytics engine module 172, and may include specific behaviors, such as loitering, crossing a line, entering a zone, unusual activity or motion, and taking an object or leaving an object behind.

In another example embodiment, operator 405 may interact with client system 104 via voice, instead of, or in combination with, keyboard, mouse, and/or touchscreen.

Although example embodiments have described a reference image for a search as being taken from an image within recorded video, in some example embodiments it may be possible to conduct a search based on a scanned photograph or still image taken by a digital camera. This may be particularly true where the photo or other image is, for example, taken recent enough such that the clothing and appearance is likely to be the same as what may be found in the video recordings.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot display content, such as a map, on a display, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
receiving at a camera system comprising a plurality of video cameras, a search request from a mobile device, the search request comprising a geographic location of the mobile device and a time range;
identifying one or more video cameras of the plurality of video cameras having a field of view including the geographic location; and
transmitting search results from the one or more video cameras of the plurality of video cameras to the mobile device, the search results comprising at least an image from a video recorded by the one or more video cameras of the plurality of video cameras during the time range.

2. The method of claim 1 wherein the search request further comprises identification of one or more facets, the method further comprising:
conducting an appearance search for the one or more facets within the video recorded by the one or more cameras of the plurality of video cameras within the time range; and
wherein the search results further comprise results of the appearance search from the one or more video cameras.

3. The method of claim 2 wherein the search results are used to generate a second search request from the mobile device, the second search request comprising one or more images from the search results.

4. The method of claim 1 wherein the search request further comprises an image, the method further comprising:
conducting an appearance search for the image within the video recorded by the one or more cameras of the plurality of video cameras within the time range; and
wherein the search results comprise the results of the appearance search from the one or more video cameras.

5. The method of claim 4 wherein the search results are used to generate a second search request from the mobile device, the second search request comprising one or more images from the search results.

6. The method of claim 4 wherein the image is taken by the mobile device.

7. The method of claim 4 wherein the image was transmitted to the mobile device from an image source.

8. The method of claim 1 wherein the geographic location is determined using a global navigation satellite system (GNSS) on the mobile device.

9. The method of claim 8 wherein the GNSS is a global positioning system (GPS).

10. A method comprising:
sending a search request from a mobile device to a camera system comprising a plurality of video cameras, the search request comprising a geographic location of the mobile device and a time range; and
receiving, at the mobile device, search results from the one or more video cameras of the plurality of video cameras to the mobile device, the search results comprising at least an image from a video recorded by the one or more video cameras of the plurality of video cameras during the time range.

11. The method of claim 10 wherein the search request further comprises one or more facets, and wherein the search results further comprise the results of an appearance search for the one or more facets within the video recorded by the one or more cameras of the plurality of video cameras within the time range.

12. The method of claim 10 wherein the search request further comprises an image, and wherein the search results further comprise the results of an appearance search for the image within the video recorded by the one or more cameras of the plurality of video cameras within the time range.

13. The method of claim 10 wherein the geographic location is determined using a global navigation satellite system (GNSS) on the mobile device.

14. The method of claim 13 wherein the GNSS is a global positioning system (GPS).

15. A system comprising:
a plurality of video cameras;
a processor; and
a memory storing program instructions that when executed by the processor cause the processor to perform:
receiving a search request from a mobile device, the search request comprising a geographic location of the mobile device and a time range;
identifying one or more video cameras of the plurality of video cameras having a field of view including the geographic location; and
transmitting search results from the one or more video cameras of the plurality of video cameras to the mobile device, the search results comprising at least an image from a video recorded by the one or more video cameras of the plurality of video cameras during the time range.

16. The system of claim 15 wherein the search request further comprises one or more facets, and wherein the program instructions that when executed by the processor cause the processor to further perform:
conducting an appearance search for the one or more facets within the video recorded by the one or more cameras of the plurality of video cameras within the time range; and
wherein the search results comprise the results of the appearance search from the one or more video cameras.

17. The system of claim 15 wherein the search request further comprises an image and wherein the program instructions that when executed by the processor cause the processor to further perform:
conducting an appearance search for the image within video recorded by the one or more cameras of the plurality of video cameras within the time range; and
wherein the search results further comprise the results of the appearance search from the one or more video cameras.

18. The system of claim 15 wherein the geographic location is determined using a global navigation satellite system (GNSS) on the mobile device.

19. The system of claim 18 wherein the GNSS is a global positioning system (GPS).

20. The system of claim 15 wherein the mobile device is a smart phone.
